(19) United States
(12) Patent Application Publication
(10) Pub. No.: US 2025/0214667 A1
(43) Pub. Date: Jul. 3, 2025

(54) E-BIKE DOCKING SYSTEM, E-BIKE, E-BIKE SYSTEM, A METHOD OF SECURING AND CHARGING ONE OR MORE E-BIKES

(71) Applicant: Frisco Project Managerment Consultancy Services Limited, Dundee (GB)

(72) Inventor: Kenneth Hoskins, Aberdeen (GB)

(21) Appl. No.: 18/851,298

(22) PCT Filed: Mar. 28, 2023
(86) PCT No.: PCT/GB2023/050802

§ 371 Date: Sep. 26, 2024

(30) Foreign Application Priority Data
Mar. 28, 2022 (GB) 2204370.7

(51) Int. Cl. B62H 3/00; B60L 53/122; B60L 53/51; B60L 53/53; B60L 53/66; B60L 53/68; B62H 5/14; B62J 6/00; B62M 6/55; H02J 50/10

(52) U.S. Cl. CPC B62H 3/00; B60L 53/122; B60L 53/51; B60L 53/53; B60L 53/66; B60L 53/68; B62H 5/147; B62J 6/00; B62M 6/55; H02J 50/10; B60L 2200/12

(57) ABSTRACT

An e-bike docking system comprises a docking arrangement for receiving and releasably coupling one or more e-bike to the docking system and a wireless charging arrangement for supplying electrical power to the one or more e-bikes when secured to the docking system. The docking arrangement comprises a lock arrangement for releasably securing the one or more e-bikes to the docking system. The docking system is configured such that when the lock arrangement is engaged, the wireless charging arrangement is positioned relative to the e-bike so as to facilitate the wireless charging of a rechargeable battery of the e-bike.

### FIELD

This relates to an e-bike docking system, an e-bike for use with the e-bike docking system, an e-bike system comprising one or more of the docking systems, a method of securing and charging one or more e-bikes using the docking system.

### BACKGROUND

Electric bicycles, commonly referred to as e-bikes, are bicycles that can be propelled using electro-motive power in addition to the manual power supplied by the rider via the pedals.

A typical e-bike comprises an onboard electric motor powered by a rechargeable battery. In some instances, the electric motor is coupled to or forms part of a hub of one of the wheels (typically the rear wheel) of the e-bike. In other instances, the electric motor is coupled to the drive train, e.g. via the crank set.

Beneficially, e-bikes reduce the amount of power that is required to be supplied by the rider and/or augments the power supplied by the rider, facilitating amongst other things improvements in performance. E-bikes also provide the advantage over fossil fuel powered vehicles in that they do not emit exhaust gasses or particulates, and so are particularly suited to urban or semi-urban environments where such emissions are often now highly restricted.

Many towns and cities now have private or municipal e-bike fleets for hire and/or provide charging facilities to encourage and facilitate the use of e-bikes.

However, there remain significant technical challenges with conventional systems and methodologies for efficiently managing fleets of e-bikes.

### SUMMARY

Aspects of the present disclosure relate to an e-bike docking system, an e-bike for use with the e-bike docking system, an e-bike system comprising one or more of the docking systems, a method of securing and charging one or more e-bikes using the docking system.

According to a first aspect, there is provided an e-bike docking system, comprising:
a docking arrangement for receiving and releasably coupling one or more e-bike to the docking system,
wherein the docking arrangement comprises a lock arrangement for releasably securing the one or more e-bikes to the docking system; and
a wireless charging arrangement for supplying electrical power to the one or more e-bikes when secured to the docking system,
wherein the docking system is configured such that when the lock arrangement is engaged, the wireless charging arrangement is positioned relative to the e-bike so as to facilitate the wireless charging of the one or more e-bike.

In use, the e-bike is engaged with the docking arrangement of the docking system, the lock arrangement securing the e-bike in position. When docked with the docking arrangement, the wireless charging arrangement is positioned relative to the e-bike, more particularly relative to a wireless charging arrangement of the e-bike, so as to facilitate the wireless charging of a rechargeable battery of the e-bike.

Beneficially, the docking system facilitates the securement and charging of one or more e-bike in a fast, secure and efficient manner.

The docking system may comprise or may be coupled to a power supply.

The power supply may be configured and/or operable to supply power to the docking arrangement and/or to the wireless charging arrangement.

The power supply may comprise or take the form of an onboard power supply, i.e. the power supply may be disposed on the docking system.

Beneficially, the provision of an onboard power supply means that the docking system can define a standalone system for securing and charging e-bikes, which does not rely on existing power infrastructure. This may in turn permit greater flexibility in terms of the number and/or types of the locations that the docking system can be utilised. This may facilitate greater coverage of a given area and/or permit the use of e-bikes in areas which, due to a reliance on proximity to mains power supply infrastructure, would not otherwise be possible with conventional systems.

The power supply may comprise or take the form of a photovoltaic power supply. The photovoltaic power supply may comprise or take the form of one or more solar panels.

As described above, the docking system comprises a docking arrangement for receiving and releasably coupling one or more e-bike to the docking system.

The docking arrangement may comprise one or more docks, each dock configured to receive and releasably couple one of the e-bikes to the docking system.

The docking arrangement may comprise one dock. In particular embodiments, however, the docking arrangement may comprise a plurality of the docks, for example but not exclusively ten docks, twenty docks or forty docks. However, it will be understood that the docking arrangement may comprise any number of docks.

As described above, the docking arrangement comprises a lock arrangement for releasably securing the one or more e-bikes to the docking system.

The lock arrangement may be powered by the power supply.

The docking system may be configured so that in the event of power supply failure or interruption the lock arrangement defines a locked configuration.

Beneficially, this ensures that in the event of power supply failure or interruption the e-bikes remain secured to the docking system.

The lock arrangement may comprise one or more locks for securing the e-bike, in particular but not exclusively a frame of the e-bike, to the docking system.

At least one of the locks for securing the e-bike to the docking system may comprise or take the form of an electro-mechanical lock. At least one of the locks for securing the e-bike to the docking system may comprise or take the form of an electro-mechanical latch. At least one of the locks for securing the e-bike to the docking system may comprise or take the form of a rotary electro-mechanical latch. At least one of the locks for securing the e-bike to the docking system may comprise or take the form of a linear electro-mechanical lock.

The at least one lock may be configurable between a locked configuration in which the e-bike is secured to the docking system and an unlocked configuration in which the e-bike is free to move relative to the docking system. The at least one lock may be configured to define the locked configuration in response to engagement of the e-bike with the lock. The at least one lock may comprise a release mechanism. The at least one lock may comprise a controller, e.g. a microcontroller. The release mechanism may be configured and/or operable to reconfigure the lock to the unlocked configuration. The release mechanism may be configured and/or operable to reconfigure the lock to the unlocked configuration in response to a command signal from the controller.

The at least one lock may comprise a latch member. The at least one lock may comprise a housing. The latch member may be configured and/or operable to pivot or rotate relative to the housing of the lock, to reconfigure the lock from the unlocked configuration to the locked configuration.

The docking arrangement may comprise a guide arrangement.

The guide arrangement may be configured and/or operable to facilitate the engagement between the e-bike and the docking system.

The guide arrangement may comprise one or more guide, such as a guide rail, slot or the like.

As described above, the docking arrangement may comprise one or a plurality of docks, and at least one of the docks of the docking arrangement may be provided with the guide arrangement.

As described above, the docking system comprises a wireless charging arrangement for supplying electrical power to the one or more e-bikes when secured to the docking system.

The wireless charging arrangement may be coupled to the power supply.

The wireless charging arrangement may comprise an inverter.

The inverter may be configured and/or operable to convert a direct electric current supply from the power supply, e.g. as may be provided by a photovoltaic power supply, into an alternating current.

The wireless charging arrangement may comprise an induction coil.

The induction coil of the wireless charging arrangement may be configured and/or operable to induce an electric current in an induction coil in the e-bike, to facilitate wireless charging of the e-bike.

In use, an alternating electric current supplied to the induction coil of the wireless charging arrangement may create a fluctuating magnetic field which induces an alternating electric current in the induction coil provided on the e-bike. The alternating electric current may then be transformed into a direct electric current, e.g. via a rectifier, which is then supplied to the rechargeable battery on the e-bike.

The docking system may comprise an enclosure.

The enclosure may comprise a roof portion. The power supply, e.g. where the power supply comprises one or more solar panels, may be disposed on, may form, or may form part of, the roof portion of the enclosure.

The enclosure may comprise one or more wall portion. The power supply may be disposed on, may form, or may form part of, the wall portion of the enclosure.

The docking system may comprise a storage locker arrangement.

The storage locker arrangement may comprise one or more lockers.

One or more locker of the storage locker arrangement may be configured, e.g. dimensioned and/or shaped, and/or operable to provide helmet storage.

The storage locker arrangement may be coupled to the power supply.

As described above, the storage locker arrangement may comprise one or a plurality of lockers, and at least one of the lockers may be provided with a lock.

At least one of the locks of the storage locker arrangement may comprise an electro-mechanical lock. The electro-mechanical lock may be microprocessor controlled. At least one of the locks of the storage locker arrangement may comprise or take the form of an electro-mechanical lock. At least one of the locks of the storage locker arrangement may comprise or take the form of an electro-mechanical latch.

The lock arrangement of the storage locker arrangement may be configured so that in the event of power supply failure or interruption the lock arrangement defines a locked configuration.

Beneficially, this ensures that in the event of power supply failure or interruption the lockers remain secure.

The docking system may comprise a communication arrangement.

The communication arrangement may be configured and/or operable to provide communication between parts of the docking system. For example, the communication arrangement may provide communication between two or more of: the docking arrangement, in particular but not exclusively the lock arrangement of the docking arrangement; the wireless charging arrangement; the power supply; and/or the storage locker arrangement.

The communication arrangement may be configured and/or operable to provide communication between one or more part of the docking system and the e-bike.

The communication arrangement may be configured and/or operable to provide communication between one or more part of the docking system and a remote location. The remote location may comprise or take the form of a mobile device such as tablet, mobile phone or the like. Alternatively or additionally, the remote location may comprise or take the form of a control room. Alternatively or additionally, the remote location may comprise or take the form of a data store, such as an online data store.

Beneficially, this permits information relating to operation of the docking system and/or the one or more e-bikes to be recorded, audited and/or interrogated.

The communication arrangement may comprise or take the form of a wireless communication arrangement. The wireless communication arrangement may comprise a radio frequency communication arrangement. The communication arrangement may comprise or take the form of a transmitter or transceiver.

The communication arrangement may comprise or take the form of a wired communication arrangement. The wired communication arrangement may comprise or take the form of an electric wire and/or optical fibre communication arrangement.

The docking system may comprise a controller. The controller may comprise or take the form of a microcontroller.

The docking system may comprise a console.

The console may comprise or take the form of a payment kiosk.

The console may comprise a user interface, such as graphical user interface (GUI), display or the like.

The docking system may be configured to receive and/or transmit power to a mains electrical system (“the grid”). Alternatively or additionally, the docking system may be configured to receive and/or transmit power to a battery of a vehicle. For example, the docking system may be configured to supply electricity so as to facilitate the charging/recharging of a 48-volt battery.

The docking system may be configured to generate hydrogen, e.g. via water electrolysis.

According to a second aspect, there is provided an e-bike for use with the e-bike docking system of the first aspect, the e-bike comprising:
an electric motor;
a rechargeable battery; and
a wireless charging arrangement for charging the rechargeable battery,
wherein the e-bike is configured to engage a lock arrangement of the e-bike docking system to releasably secure the e-bike to the docking system, and
wherein the e-bike is configured such that when the e-bike engages the lock arrangement of the e-bike docking system, the wireless charging arrangement of the e-bike is positioned relative to the wireless charging arrangement of the e-bike so as to facilitate the wireless charging of the rechargeable battery of the e-bike.

The electric motor may be coupled to or form part of a hub of one of the wheels (typically the rear wheel) of the e-bike.

Alternatively or additionally, the electric motor may be coupled to the drive train, e.g. via the crank set of the e-bike.

The rechargeable battery may comprise one or more battery cells. The rechargeable battery may comprise or take the form of a Lithium-ion battery.

The rechargeable battery may be located at any suitable location on the e-bike. For example, the rechargeable battery may be disposed on a frame of the e-bike.

The rechargeable battery may be detachably coupled to the e-bike. The e-bike may comprise a coupling arrangement for coupling the rechargeable battery to the e-bike. The coupling arrangement may comprise or take the form of a bracket. Beneficially, providing a rechargeable battery which is detachably coupled to the e-bike permits the battery to be removed for repair or replacement.

The e-bike may comprise a lock arrangement for securing the rechargeable battery to the e-bike.

Beneficially, the provision of a lock arrangement may prevent or restrict unauthorised removal of the rechargeable battery.

Alternatively, the rechargeable battery may be disposed within or integrally formed with the e-bike, for example within the frame.

The e-bike may comprise a lock arrangement.

The lock arrangement of the e-bike may comprise or take the form of an onboard lock arrangement.

The lock arrangement may be configured and/or operable to releasably secure one or more wheels, in particular but not exclusively a rear wheel, of the e-bike to the frame of the e-bike.

The lock arrangement may comprise one or more locks for securing a wheel, of the e-bike to the docking system.

At least one of the locks for securing the wheel of the e-bike to the docking system may comprise an electro-mechanical lock. The electro-mechanical lock may be microprocessor controlled. At least one of the locks for securing the wheel to the docking system may comprise or take the form of an electro-mechanical lock. At least one of the locks for securing the wheel of the e-bike to the docking system may comprise or take the form of an electro-mechanical latch. At least one of the locks for securing the wheel of the e-bike to the docking system may comprise or take the form of a rotary electro-mechanical latch. At least one of the locks for securing the wheel of the e-bike to the docking system may comprise or take the form of a linear electro-mechanical lock.

As described above, the docking arrangement may comprise one or a plurality of docks, and each dock of the docking arrangement may be provided with a lock for securing the frame of the e-bike to the docking system.

The wireless charging arrangement of the e-bike may be coupled to the rechargeable battery.

The wireless charging arrangement of the e-bike may comprise an induction coil.

The induction coil of the wireless charging arrangement of the docking system may be configured and/or operable to induce an electric current in the induction coil in the e-bike, to facilitate wireless charging of the rechargeable battery of the e-bike.

The wireless charging arrangement of the e-bike may comprise a rectifier.

In use, the alternating electric current induced in the induction coil provided in or on the e-bike may be transformed into a direct electric current via the rectifier, which is then supplied to the rechargeable battery.

The e-bike may comprise a user interface.

The user interface may comprise or take the form of an information panel.

The e-bike may comprise a controller. The controller may comprise or take the form of a microcontroller.

The e-bike may comprise a light arrangement.

The light arrangement may comprise one or more light sources disposed on a front surface of the e-bike. At least one of the light sources disposed on a front surface of the e-bike may comprise or take the form of a white light source.

The light arrangement may comprise one or more light sources disposed on a rear surface of the e-bike. At least one of the light sources disposed on a rear surface of the e-bike may comprise or take the form of a red light source.

The light arrangement may comprise one or more light sources disposed on one or both side surfaces of the e-bike. At least one of the light sources disposed on one or both side surfaces of the e-bike may comprise or take the form of an amber, yellow or orange light source.

In particular, the light arrangement may comprise one or more light sources on the front surface of the e-bike; both side surfaces of the e-bike and the rear surface of the e-bike.

Beneficially, the provision of a light arrangement having light sources on the front, sides and rear surfaces of the e-bike provide a 360 degree light arrangement.

At least one of the light sources of the light arrangement may comprise or take the form of flashing light source.

According to a third aspect, there is provided an e-bike system comprising one or more docking systems according to the first aspect.

The e-bike system may comprise a plurality of e-bikes. At least one of the e-bikes may comprise an e-bike according to the second aspect.

According to another aspect, there is provided a method of securing and charging one or more e-bikes using the docking system of the first aspect.

The invention is defined by the appended claims. However, for the purposes of the present disclosure it will be understood that any of the features defined above or described below may be utilised in isolation or in combination. For example, features described above in relation to one of the above aspects or below in relation to the detailed description below may be utilised in any other aspect, or together form a new aspect.

### BRIEF DESCRIPTION OF THE DRAWINGS

These and other aspects will now be described by way of example with reference to the accompanying drawings, of which:

FIG. 1 shows a perspective view of an e-bike docking system;

FIG. 2 shows another perspective view of the e-bike docking system shown in FIG. 1;

FIGS. 3, 4 and 5 show a dock of the docking system shown in FIG. 1 in more detail;

FIGS. 6 to 9 show a lock arrangement of docking system shown in FIG. 1 in more detail;

FIGS. 10 to 12 show a wireless charging arrangement of docking system shown in FIG. 1 in more detail;

FIGS. 13 and 14 show perspective views of a storage locker arrangement and console of the docking system shown in FIG. 1;

FIG. 15 shows an e-bike for use in the docking system shown in FIG. 1;

FIGS. 16 and 17 show a lock arrangement of the e-bike shown in FIG. 15;

FIGS. 18 and 19 show an alternative docking system;

FIG. 20 shows a further alternative docking system;

FIG. 21 shows a further alternative docking system; and

FIG. 22 shows an e-bike system comprising a plurality of e-bike docking systems.

### DETAILED DESCRIPTION OF THE DRAWINGS

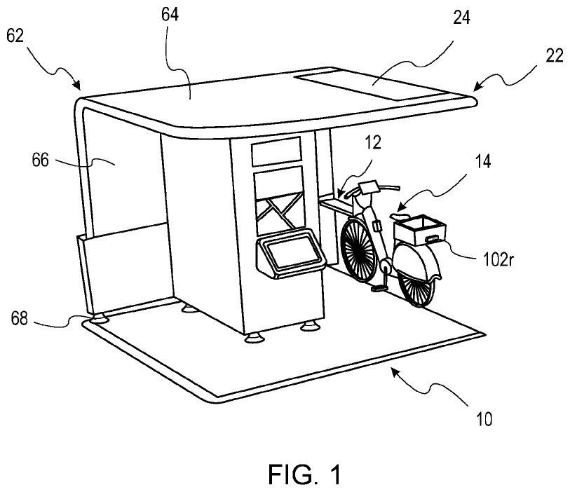

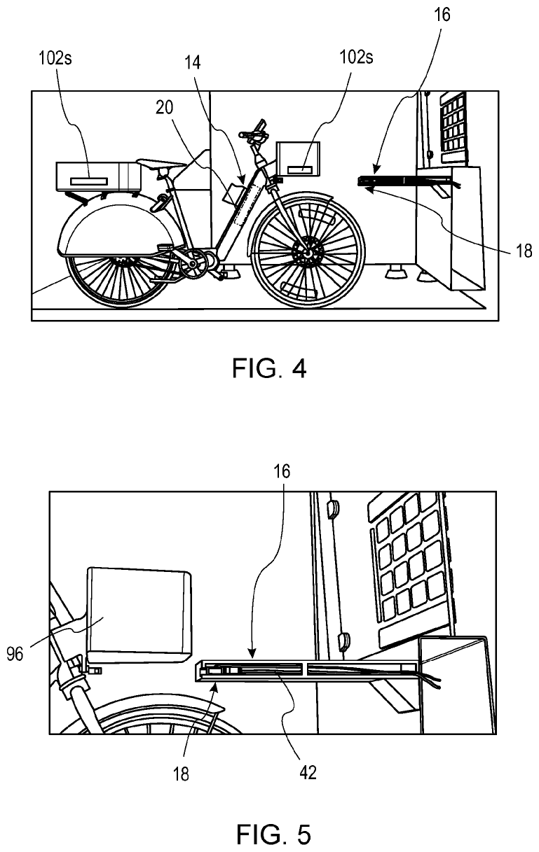

Referring first to FIGS. 1 to 5 of the accompanying drawings, there is shown an e-bike docking system, generally denoted 10.

As shown, the docking system 10 comprises a docking arrangement, generally denoted 12, for receiving and releasably coupling an e-bike 14 to the docking system 10 and a wireless charging arrangement, generally denoted 16, for supplying electrical power to the e-bike 14 when secured to the docking system 10 so as to facilitate wireless charging of the e-bike 14.

The docking arrangement 12 comprises a lock arrangement 18 for releasably securing the e-bike 14 to the docking system 10. The docking system 10 is configured such that when the lock arrangement 18 is engaged, the wireless charging arrangement 16 is positioned relative to the e-bike 14, so as to facilitate the wireless charging of the e-bike 14.

In use, the e-bike 14 is engaged with the docking arrangement 12 of the docking system 10, the lock arrangement 18 securing the e-bike 14 in position. When docked with the docking arrangement 12, the wireless charging arrangement 16 is positioned relative to the e-bike 14, so as to facilitate the wireless charging of a rechargeable battery 20 (shown most clearly in FIG. 12) of the e-bike 14.

Beneficially, the docking system 10 facilitates the securement and charging of the e-bike 14 in a fast, secure and efficient manner.

The docking system 10 comprises a power supply, generally denoted 22, configured and/or operable to supply power to the docking arrangement 12 and the wireless charging arrangement 16.

In the illustrated docking system 10, the power supply 22 takes the form of an onboard power supply, i.e. the power supply 22 is disposed on the docking system 10.

Beneficially, the provision of onboard power supply 22 means that the docking system 10 can define a standalone system for securing and charging e-bikes 14, which does not rely on existing power infrastructure. This may in turn permit greater flexibility in terms of the number and/or types of the locations that the docking system can be utilised. This may facilitate greater coverage of a given area and/or permit the use of e-bikes in areas which, due to a reliance on proximity to mains power supply infrastructure, would not otherwise be possible with conventional systems.

As shown in FIG. 1, the power supply 22 takes the form of a photovoltaic power supply comprising one or more solar panels 24 (one solar panel 24 is shown in FIG. 1).

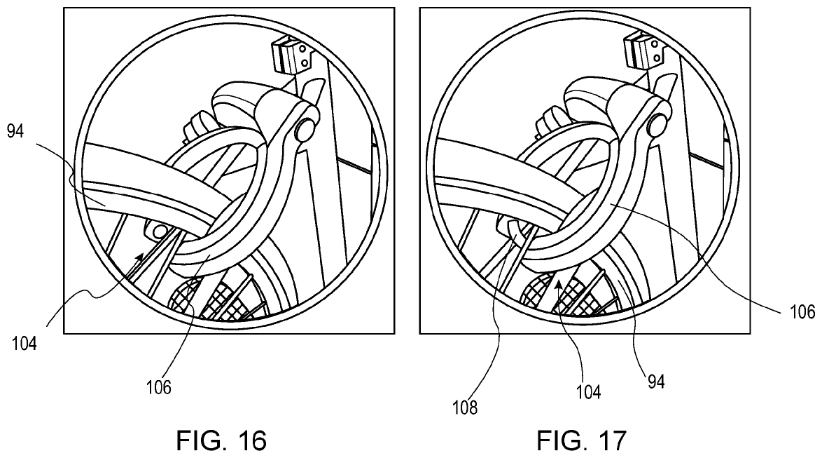

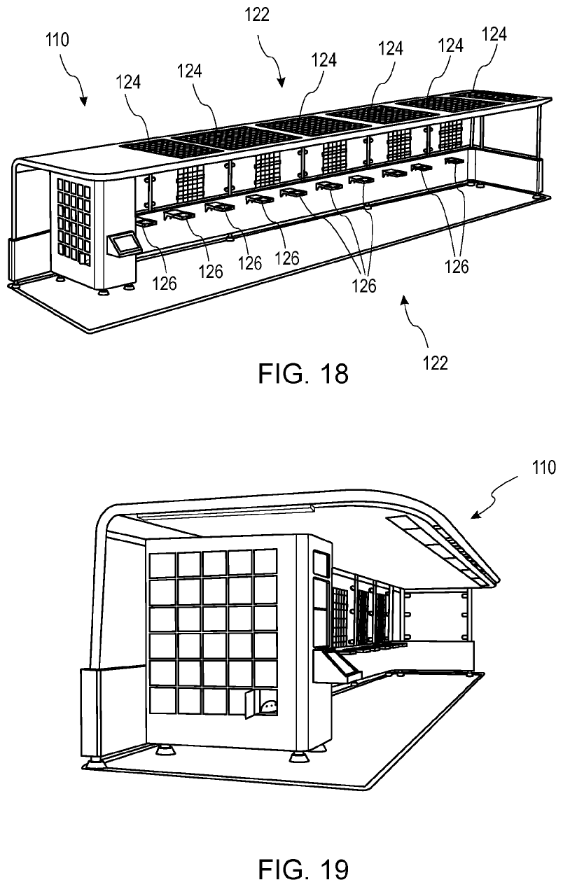

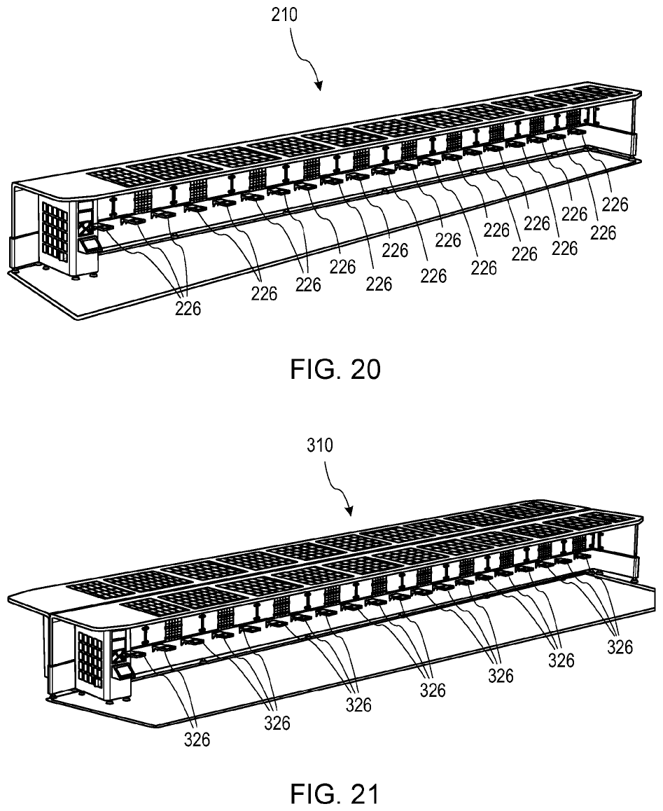

As described above, the docking system 10 comprises a docking arrangement 12, the docking arrangement 12 comprising a dock 26 configured to receive and releasably couple the e-bike 14 to the docking system 12. In the illustrated docking system 10, the docking arrangement 12 comprises one dock 26. However, it will be understood that the docking arrangement 12 may comprise any number of docks 26, for example but not exclusively ten docks (as shown in FIGS. 18 and 19), twenty docks (as shown in FIG. 20) or forty docks (as shown in FIG. 21).

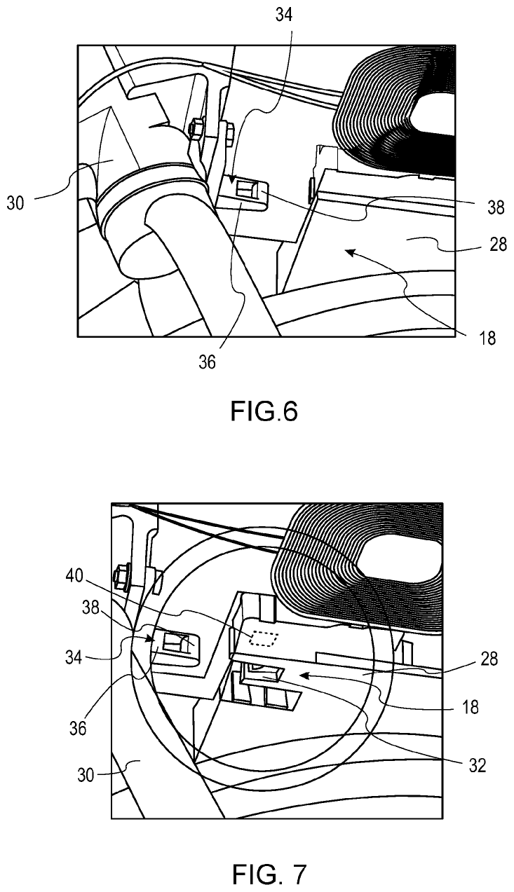

FIGS. 6 to 9 of the accompanying drawings show the lock arrangement 18 of the docking arrangement 12 of the docking system 10 shown in FIG. 1 in more detail.

As shown, the lock arrangement 18 comprises a lock 28 for securing a frame 30 of the e-bike 14 to the dock 26. In the illustrated docking system 10, the lock 28 takes the form of a rotary electro-mechanical latch having a rotary latch member 32 that is configured to receive and be pivoted by an actuator, generally denoted 34, provided on the e-bike 14. As shown, the actuator 34 comprises a boss portion 36 coupled to and projecting from the frame 30 of the e-bike 14 and has a pin 38 configured to engage the rotary latch member 32. It will be recognised that the actuator 34 may take any suitable form and may be coupled to or integrally formed any part of the e-bike 14.

In use, linear motion of the e-bike 14 towards the dock 26 engages the pin 38 with the latch member 32. Further linear motion of the e-bike 14 towards the dock 26 causes the pin 38 to pivot the latch member 32 out of the way of the pin 38 such that the latch member 32 locates around the pin 38. In this way, the actuator 34 is manually engaged with the lock 28 to secure the e-bike 14 to the dock 26. The lock 28 further comprises a microcontroller 40 which permits the lock 28 to be released. In the illustrated docking system 10, the lock 28 is coupled to and powered by the power supply 22 via wiring 42 (shown in FIG. 5).

In use, on receiving an unlock signal from the microcontroller 40, the latch member 32 is released, permitting the e-bike 14 to be removed from the dock 26.

The docking system 10 is configured so that in the event of power supply failure or interruption the lock 28 defines a locked configuration.

Beneficially, this ensures that in the event of power supply failure or interruption the e-bike 14 remain secured to the docking system 10.

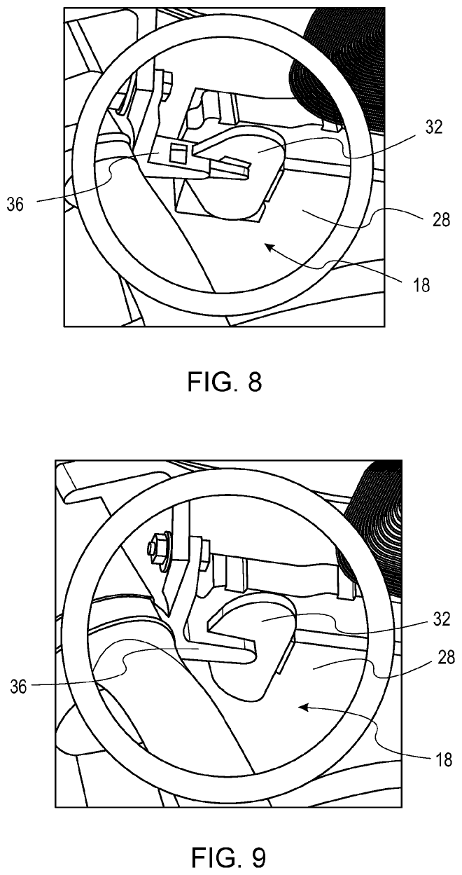

FIGS. 10 to 12 of the accompanying drawings show the wireless charging arrangement 16 of the docking system 10 in more detail.

As shown, the wireless charging arrangement 16 is coupled to and powered by the power supply 22 via wiring 44.

The wireless charging arrangement 16 comprises an inverter 46. The inverter 46 is configured and/or operable to convert a direct electric current supply from the power supply 22, e.g. as may be provided by one or more solar panels 24 of a photovoltaic power supply, into an alternating current.

The wireless charging arrangement 16 comprises an induction coil 48 disposed in the dock 26. The induction coil 48 is coupled to the inverter 46 via electrical wiring 50. The induction coil 48 of the wireless charging arrangement 16 is configured and/or operable to induce an alternating electric current in an induction coil 52 of a wireless charging arrangement 54 provided in the e-bike 14, to facilitate wireless charging of the rechargeable battery 20 of the e-bike 14.

In use, the alternating electric current supplied to the induction coil 48 of the wireless charging arrangement 16 creates a fluctuating magnetic field which induces the alternating electric current in the induction coil 52 provided on the e-bike 14 when the e-bike 14 is locked. The induction coil 52 is coupled to a rectifier 56 provided in the e-bike 14 via wiring 58. The alternating electric current induced in the induction coil 52 is transformed by the rectifier 56 into a direct electric current which is then supplied to the rechargeable battery 20 on the e-bike 14 via wiring 60.

As shown in FIG. 10, and as described further below with reference to FIG. 14 of the accompanying drawings, the power supply 22 also powers a battery module 80 of the docking system 10.

It will be understood that the docking system 10 may take a number of different forms. For example, and referring again to FIG. 1, the illustrated docking system 10 comprises an enclosure 62 having a roof portion 64 and a wall portion 66. As shown, the solar panel 24 of the onboard power supply 22 is disposed on the roof portion 64 of the enclosure 60. However, it will be understood that the docking system 10 may alternatively or additionally comprise one or more solar panel 24 on the wall portion 66.

As shown in FIG. 1, in the illustrated docking system 10 the enclosure 62 comprises one or more feet 68.

Beneficially, the docking system 10 may be installed at a given location without the requirement for significant foundations. This permits the docking system 10 to be located in environments where significant foundations are not possible, e.g. due to the terrain, and/or in environments where permanent installation is not permitted, e.g. due to planning laws, or historical and/or environmental sensitivities at a given site. This may in turn permit greater flexibility in terms of the number and/or types of the locations that the docking system can be utilised. This may facilitate greater coverage of a given area and/or permit the use of e-bikes in areas which would not otherwise be possible with conventional systems.

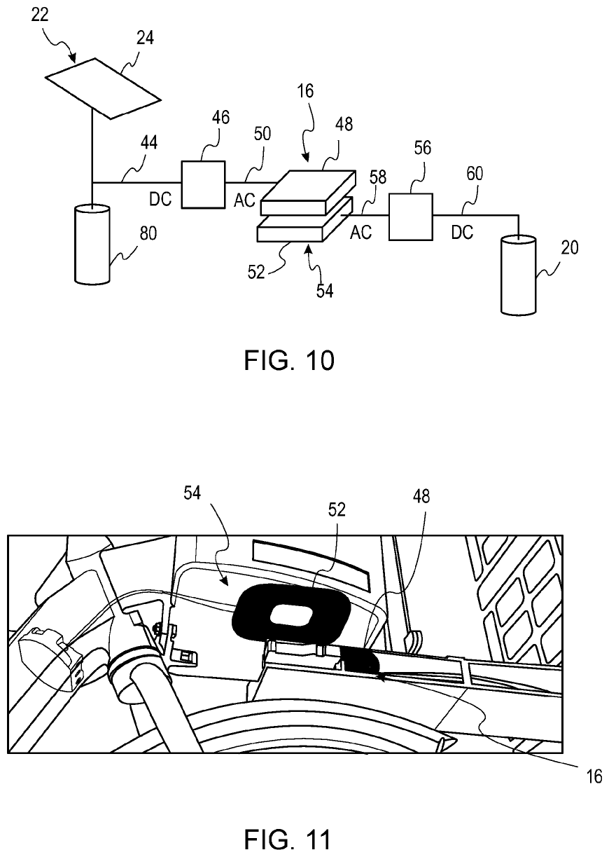

Referring also now to FIGS. 13 and 14 of the accompanying drawings, the docking system 10 further comprises a storage locker arrangement, generally denoted 70 and a console, generally denoted 72.

As shown in FIG. 13, the storage locker arrangement 70 comprises a plurality of lockers 74. In the illustrated docking system 10, the lockers 74 of the storage locker arrangement 70 are configured, e.g. dimensioned and/or shaped, to provide storage for one or more helmet H.

The storage locker arrangement 70 is coupled to the power supply 22 and comprises a lock arrangement (not shown) configured and/or operable to control access to the lockers 74.

The lock arrangement of the storage locker arrangement 70 is configured so that in the event of power supply failure or interruption the lock arrangement defines a locked configuration.

Beneficially, this ensures that in the event of power supply failure or interruption the lockers 74 remain secure.

As shown in FIG. 14, the console 72 comprises or takes the form of a payment kiosk having an information panel or screen 76 and a graphical user interface (GUI) 78. While the illustrated console 72 comprises an information panel 76 and a separate GUI 78, it will be understood that in some embodiments the console 72 may comprise one or other of the information panel 76 and the GUI 78, or that the information panel 76 and the GUI 78 may be provided by a single device. In other embodiments, the docking system 10 may not have a console 72, with user interaction being provided via a user's remote device such as a mobile phone, tablet or the like.

As described above, the docking system 10 further comprises battery module 80. In the illustrated docking system 10, the battery module 80 comprises or takes the form of a rechargeable battery. The battery module 80 is coupled to and powered by the solar panel 24 of the power supply 22.

In use, the battery 80 provides power to components of the docking system 10.

The docking system 10 may be configured to receive and/or transmit power to a mains electrical system (“the grid”). Alternatively or additionally, the docking system 10 may be configured to receive and/or transmit power to a battery of a vehicle. For example, the docking system may be configured to supply electricity so as to facilitate the charging/recharging of a 48-volt battery such as may be used by a vehicle.

As shown in FIG. 14, the docking system 10 comprises a security module 82, an import/export module 84, and a power management module 86.

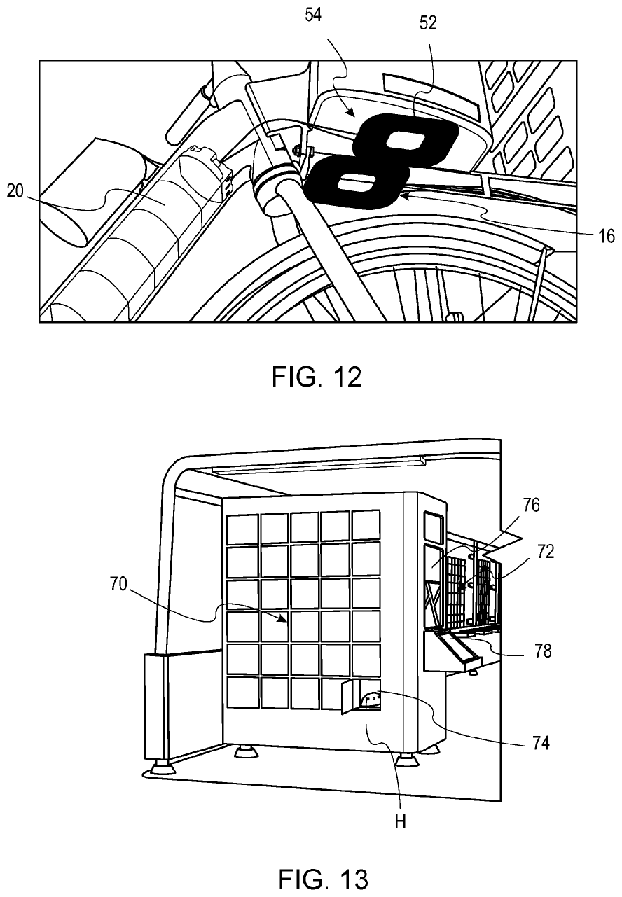

FIG. 15 of the accompanying drawings shows a perspective view of the e-bike 14 for use with the docking system 10.

As shown in FIG. 15 and as described above, the e-bike 14 comprises rechargeable battery 20, which in the illustrated e-bike 14 comprises or takes the form of a Lithium-ion battery. In the illustrated e-bike 14, the rechargeable battery 20 is disposed within or integrally formed with the frame 30 of the e-bike 14.

The rechargeable battery 20 is coupled to and powers an electric motor 88. In the illustrated e-bike 14, the electric motor 88 is coupled to the drive train, generally denoted 90, via the crank set 92 of the e-bike 14. However, it will be understood that the electric motor 88 may alternatively be coupled to or form part of a hub of one of the wheels (typically the rear wheel 94) of the e-bike 14, or may be located at any other suitable location.

As described above, the e-bike 14 comprise wireless charging arrangement 54 (shown in FIGS. 10 to 12) comprising induction coil 52, which in the illustrated e-bike 14 is disposed in a front basket 96 of the e-bike 14. The induction coil 52 is coupled to the rechargeable battery 20 via the rectifier 56. As described above, the induction coil 48 of the wireless charging arrangement 16 of the docking system 10 is configured and/or operable to induce an electric current in the induction coil 52 in the e-bike 14, to facilitate wireless charging of the rechargeable battery 20 of the e-bike 14.

The induction coil 48 of the wireless charging arrangement 16 of the docking system 10 is aligned with the induction coil 52 disposed in the front basket 96 of the e-bike 14 when the lock arrangement 18 is engaged, i.e., when the lock arrangement 18 secures the e-bike 14 in position. Specifically, when the lock 28, e.g., the electro-mechanical latch, receives the e-bike 14, e.g., the actuator 34 coupled to and projecting frame the frame 30 of the e-bike 14, the coils 48 and 52 are aligned. Further, when the respective coils 48 and 52 are aligned, wireless power transfer from the charging arrangement 16 to the e-bike 14 is maximised. This may reduce charging time and improve usability of the docking system 10.

As shown in FIG. 15, the e-bike 14 further comprises a user interface 98, which in the illustrated e-bike 14 comprises or takes the form of an information panel.

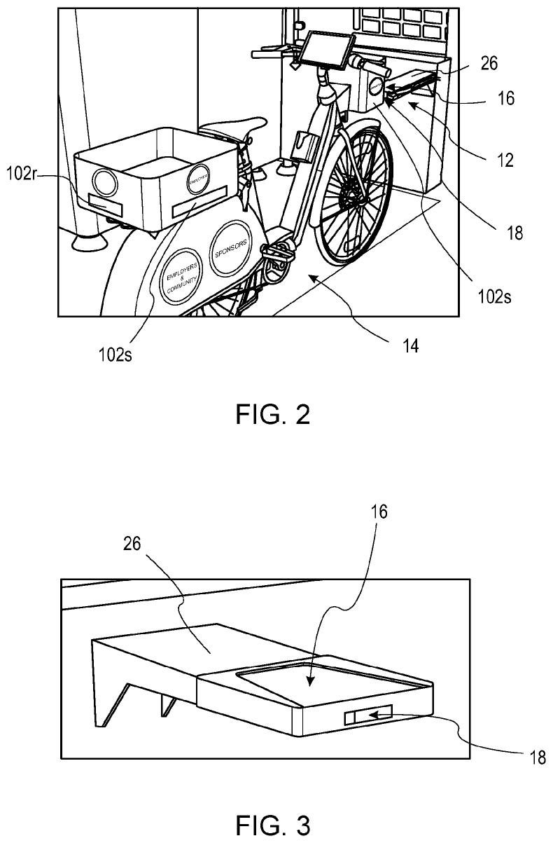

The e-bike 14 further comprises a light arrangement, generally denoted 100. In the illustrated e-bike 14, the light arrangement 100 comprises a white light source 102f on a front surface of the e-bike 14 (shown in FIG. 15), a red light source 102r (shown in FIGS. 1 and 2) on a rear surface of the e-bike 14 and amber light sources 102s on side surfaces of the e-bike 14 (the light sources 102s on the left side of the e-bike 14 are shown in FIG. 15 and the light sources 102s on the right side of the e-bike 14 are shown in FIGS. 2 and 4).

Beneficially, the provision of a light arrangement 100 having light sources 102f, 102r, 102s on the front, rear and side surfaces of the e-bike provide a 360 degree light arrangement on the body of the e-bike 14.

At least one of the light sources 102f, 102r, 102s of the light arrangement 100 may comprise or take the form of flashing light source.

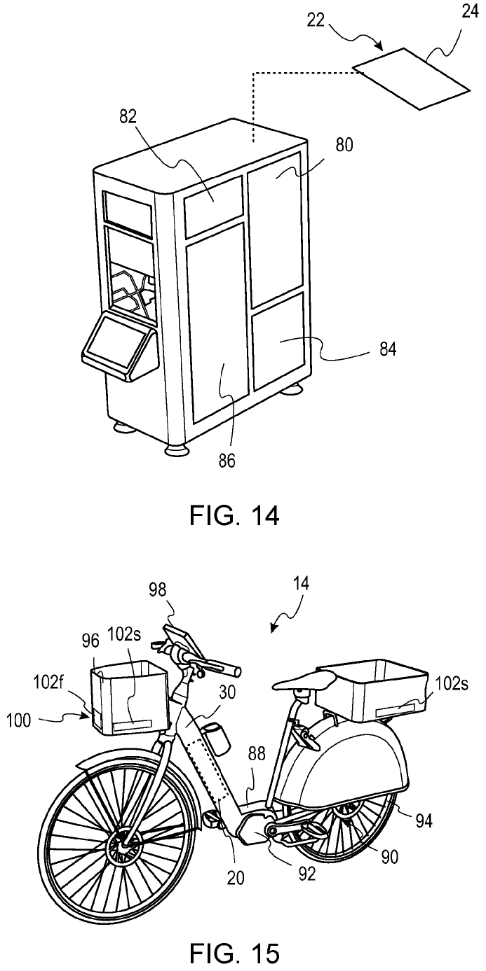

Referring now also to FIGS. 16 and 17 of the accompanying drawings, the e-bike 14 further comprises a lock arrangement, generally denoted 104. The lock arrangement 104 is configured and/or operable to secure a wheel, in particular but not exclusively the rear wheel 94, of the e-bike 14 to the frame 30 of the e-bike 14.

As shown, the lock arrangement 104 comprises or takes the form of an electro-mechanical lock. The lock arrangement 104 comprises a housing 106 and a latch member 108 (shown in FIG. 17). The lock arrangement 104 is coupled to the rechargeable battery 20.

The lock arrangement 104 further comprises a microcontroller (not shown). In use, on receiving a lock signal from the microcontroller, the latch member 108 extends from the housing 106, such that the lock arrangement prevents removal of the wheel 94. On receiving an unlock signal from the microcontroller, the latch member 108 is retracted, permitting the wheel 40 to be removed.

It will be understood that various modifications may be made without departing from the scope of the invention as defined in the claims.

For example, FIGS. 18 and 19 of the accompanying drawings show an alternative docking system 110.

As shown, the docking system 110 comprises an onboard power supply 122 in the form of a photovoltaic power supply comprising a plurality of solar panels 124 (six solar panels 124 are shown in FIG. 18).

The docking system 110 comprises docking arrangement 112 comprising a plurality of docks 126. In the illustrated docking system 110, the docking arrangement 112 comprises ten docks 126.

However, as described above it will be understood that any number of docks may be provided. For example, FIG. 20 shows an alternative docking system 210 comprising twenty docks 226 while FIG. 21 shows a further alternative docking system 310 comprising forty docks 326 (twenty docks 326 are shown with the remaining twenty provided on the other side of the docking system 310).

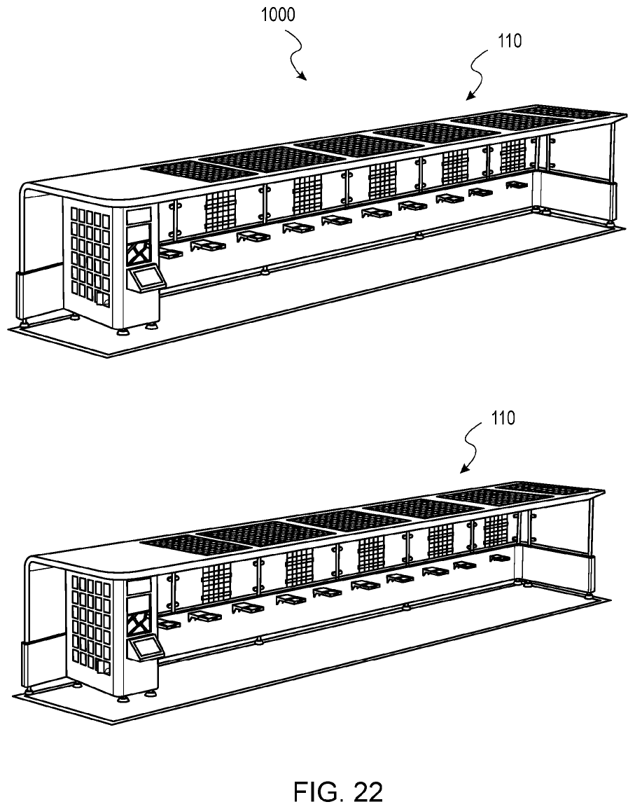

An e-bike system 1000 is shown in FIG. 22 of the accompanying drawings. The e-bike system 1000 comprises a plurality of the e-bike docking systems 110. However, it will be recognised that the e-bike system 1000 may alternatively or additionally comprise one or more of the e-bike docking systems 10, 210, 310.

1. An e-bike docking system, comprising:
a docking arrangement for receiving and releasably coupling one or more e-bike to the docking system,
wherein the docking arrangement comprises a lock arrangement for releasably securing the one or more e-bikes to the docking system; and
a wireless charging arrangement for supplying electrical power to the one or more e-bikes when secured to the docking system,
wherein the docking system is configured such that when the lock arrangement is engaged, the wireless charging arrangement is positioned relative to the e-bike so as to facilitate the wireless charging of the one or more e-bike.

2. The docking system of claim 1, comprising or coupled to a power supply configured and/or operable to supply power to the docking arrangement and/or to the wireless charging arrangement.

3. The docking system of claim 2, wherein the power supply comprises one of an onboard power supply and a photovoltaic power supply.

4. (canceled)

5. The docking system of claim 1, wherein the docking arrangement comprises one or more docks, each dock configured to receive and releasably couple one of the e-bikes to the docking system.

6. The docking system of claim 1, wherein the lock arrangement is coupled to and powered by the power supply.

7. The docking system of claim 1, wherein the lock arrangement comprises one or more locks for securing the e-bike to the docking system.

8. The docking system of claim 7, wherein the one or more locks secure a frame of the e-bike to the docking system, and/or wherein at least one of the locks for securing the e-bike to the docking system comprises an electro-mechanical lock.

9. (canceled)

10. The docking system of claim 98, wherein the electro-mechanical lock comprises or takes the form of a rotary electro-mechanical latch.

11. The docking system of claim 1, wherein the wireless charging arrangement is coupled to and powered by the power supply.

12. The docking system of claim 1, wherein the wireless charging arrangement comprises an induction coil, and wherein the induction coil of the wireless charging arrangement is configured and/or operable to induce an electric current in an induction coil in the e-bike, to facilitate wireless charging of the e-bike.

13.-14. (canceled)

15. The docking system of claim 1, comprising an enclosure wherein the power supply comprises an onboard power supply, wherein the enclosure comprises a roof portion and wherein the power supply is disposed on, forms, or forms part of, the roof portion of the enclosure.

16. The docking system of claim 1, comprising an enclosure wherein the power supply comprises an onboard power supply, wherein the enclosure comprises a wall portion and wherein the power supply is disposed on, forms, or forms part of, the wall portion of the enclosure.

17. The docking system of claim 1, comprising a communication arrangement, and wherein the communication arrangement is configured and/or operable to provide communication between:
two or more parts of the docking arrangement; and/or
one or more part of the docking system and the e-bike.

18. (canceled)

19. The docking system of claim 17, wherein the communication arrangement is configured and/or operable to provide communication between one or more part of the docking system and a remote location, the remote location comprising:
a mobile device;
a control room; and/or
a data store.

20. The docking system of claim 17, wherein the communication arrangement comprises a wireless communication arrangement.

21. An e-bike for use with the e-bike docking system of claim 1, the e-bike comprising:
an electric motor;
a rechargeable battery; and
a wireless charging arrangement for charging the rechargeable battery,
wherein the e-bike is configured to engage a lock arrangement of the e-bike docking system to releasably secure the e-bike to the docking system, and
wherein the e-bike is configured such that when the e-bike engages the lock arrangement of the e-bike docking system, the wireless charging arrangement of the e-bike is positioned relative to the wireless charging arrangement of the e-bike so as to facilitate the wireless charging of the rechargeable battery of the e-bike.

22. The e-bike of claim 21, comprising a lock arrangement, wherein the lock arrangement comprises one or more locks for securing a wheel of the e-bike, and wherein at least one of the locks for securing the wheel of the e-bike comprises or takes the form of an electro-mechanical lock.

23. (canceled)

24. The e-bike of claim 21, comprising a light arrangement, wherein the light arrangement comprises:
one or more light sources on a front surface of the e-bike;
both side surfaces of the e-bike; and
a rear surface of the e-bike.

25. An e-bike system comprising one or more docking systems according to claim 1.

26. A method of securing and charging one or more e-bikes using the docking system according to claim 1.
